(19) United States
(12) Patent Application Publication
(10) Pub. No.: US 2025/0145910 A1
(43) Pub. Date: May 8, 2025

(54) DETERGENT COMPOSITIONS CONTAINING A BRANCHED SURFACTANT, A XYLOGLUCANASE AND A PERFUME

(71) Applicant: The Procter & Gamble Company, Cincinnati, OH (US)

(72) Inventors: Patrick Christopher STENGER, Fairfield, OH (US); Melanie Beth GROSSE, Villa Hills, KY (US)

(21) Appl. No.: 18/501,344

(22) Filed: Nov. 3, 2023

(51) Int. Cl. C11D 3/34; C11D 3/386; C11D 3/50; C11D 11/00

(52) U.S. Cl. CPC C11D 3/3409; C11D 3/38636; C11D 3/50; C11D 2111/12

(57) ABSTRACT

The present invention relates generally to detergent compositions and, more specifically, to detergent compositions containing a branched surfactant, a xyloglucanase and perfume.

### TECHNICAL FIELD

The present invention relates generally to detergent compositions and, more specifically, to detergent compositions containing a branched surfactant, a xyloglucanase and a perfume.

### BACKGROUND

There is a continuous desire to provide detergent compositions that are stable, deliver good cleaning and an improved fragrance experience to the user. Unfortunately, some of the detergent components can impair the capacity of the detergent to provide a good fragrance experience.

The objective of the present invention is to provide a detergent that is stable, provides good cleaning, good care and good olfactive experience.

### SUMMARY

The present invention relates to a detergent composition comprising from about 1% to about 80%, preferably from about 5 to about 40% by weight of the composition of a first surfactant, where the first surfactant comprises, preferably consists essentially of a mixture of surfactant isomers of Formula I and surfactants of Formula II:

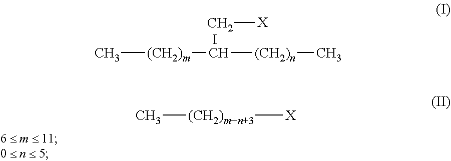

wherein from about 50% to about 100% by weight of the first surfactant are isomers having m+n=11; wherein between about 25% to about 50% of the mixture of surfactant isomers of Formula I have n=0; wherein from about 0.001% to about 25% by weight of the first surfactant are surfactants of Formula II; and wherein X is a hydrophilic moiety. The detergent compositions further comprise a xyloglucanase and a perfume and optionally one or more adjunct cleaning additives. Preferably the detergent composition is substantially free of optical brightener and preferably substantially free of borate.

The present invention further relates to methods of laundering fabric using the detergent composition of the invention. It also relates to the use of a detergent composition comprising the first surfactant, a xyloglucanase and a perfume, for laundering fabric to provide improved olfactory experience.

### DETAILED DESCRIPTION

Features and benefits of the present invention will become apparent from the following description, which includes examples intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, the articles including “the,” “a” and “an” when used in a claim or in the specification, are understood to mean one or more of what is claimed or described.

As used herein, the terms “include,” “includes” and “including” are meant to be non-limiting.

As used herein, the term “gallon” refers to a “US gallon.”

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, 0.25%, 0.1%, 0.05%, or 0.01%, or even 0%, by weight of the composition, of the component.

As used herein, the term “soiled material” is used non-specifically and may refer to any type of flexible material consisting of a network of natural or artificial fibers, including natural, artificial, and synthetic fibers, such as, but not limited to, cotton, linen, wool, polyester, nylon, silk, acrylic, and the like, as well as various blends and combinations. Soiled material may further refer to any type of hard surface, including natural, artificial, or synthetic surfaces, such as, but not limited to, tile, granite, grout, glass, composite, vinyl, hardwood, metal, cooking surfaces, plastic, and the like, as well as blends and combinations.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All cited patents and other documents are, in relevant part, incorporated by reference as if fully restated herein. The citation of any patent or other document is not an admission that the cited patent or other document is prior art with respect to the present invention.

In this description, all concentrations and ratios are on a weight basis of the detergent composition unless otherwise specified.

### Detergent Composition

As used herein the phrase “detergent composition” or “cleaning composition” includes compositions and formulations designed for cleaning soiled material. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation. The detergent compositions may have a form selected from liquid, powder, single-phase or multi-phase unit dose, pouch, tablet, gel, paste, bar, or flake. Preferably, the detergent composition of the invention is a laundry detergent composition.

### Laundry Detergent Composition:

The laundry detergent composition can be in any suitable form, such as liquid, paste, granular, solid, powder, or in conjunction with a carrier such as a substrate. Preferred laundry detergent compositions are either liquid or granular, with liquid being most preferred.

As used herein, “liquid detergent composition” refers to liquid detergent composition which is fluid, and preferably capable of wetting and cleaning a fabric, e.g., clothing in a domestic washing machine. As used herein, “laundry detergent composition” refers to compositions suitable for washing clothes. The composition can include solids or gases in suitably subdivided form, but the overall composition excludes product forms which are non-fluid overall, such as tablets or granules. The liquid laundry detergent composition preferably has a density in the range from 0.9 to 1.3 grams per cubic centimeter, more specifically from 1.00 to 1.10 grams per cubic centimeter, excluding any solid additives but including any bubbles, if present.

Aqueous liquid laundry detergent compositions are preferred. For such aqueous liquid laundry detergent compositions, the water content can be present at a level of from 5% to 99%, preferably from 15% to 90%, more preferably from 25% to 80% by weight of the liquid detergent composition.

The pH range of the detergent composition may be from 7.5 to 9.5, preferably from pH 8 to 9.

The detergent composition can also be encapsulated in a water soluble film, to form a unit dose article. Such unit dose articles comprise a detergent composition of the present invention, wherein the detergent composition comprises less than 20%, preferably less than 15%, more preferably less than 10% by weight of water, and the detergent composition is enclosed in a water-soluble or dispersible film. Such unit-dose articles can be formed using any means known in the art.

Suitable water soluble pouch materials include polymers, copolymers or derivatives thereof. Preferred polymers, copolymers or derivatives thereof can be selected from the group consisting of: polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof.

### Surfactant

The detergent compositions of the invention may comprise one or more surfactants.

In particular, the detergent compositions of the invention contain 2-alkyl primary alkyl alcohol sulfates and 2-alkyl primary alkyl alcohol ethoxy sulfates having specific alkyl chain length distributions, which provide increased stain removal (particularly in cold water). 2-alkyl branched alcohols (and the 2-alkyl branched alkyl sulfates and 2-alkyl branched alkyl ethoxy sulfates and other surfactants derived from them) are positional isomers, where the location of the hydroxymethyl group (consisting of a methylene bridge (—CH₂— unit) connected to a hydroxy (—OH) group) on the carbon chain varies. Thus, a 2-alkyl branched alkyl alcohol is generally composed of a mixture of positional isomers. Furthermore, it is well known that fatty alcohols, such as 2-alkyl branched alcohols, and surfactants are characterized by chain length distributions. In other words, fatty alcohols and surfactants are generally made up of a blend of molecules having different alkyl chain lengths (though it is possible to obtain single chain-length cuts). Notably, the 2-alkyl primary alcohols described herein, which may have specific alkyl chain length distributions and/or specific fractions of certain positional isomers, cannot be obtained by simply blending commercially available materials. Specifically, the distribution of from about 50% to about 100% by weight surfactants having m+n=11 is not achievable by blending commercially available materials.

The detergent composition comprises from about 1% to about 80% or from 5 to 40%, or from 10 to 30% by weight of the composition of a first surfactant, wherein said first surfactant comprises, preferably consists essentially of a mixture of surfactant isomers of Formula I and surfactants of Formula II:

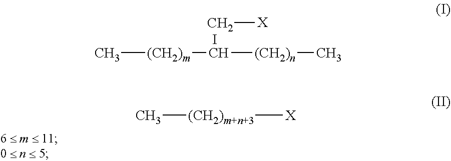

wherein from about 50% to about 100% by weight of the first surfactant are isomers having m+n=11; wherein from about 25% to about 50% of the mixture of surfactant isomers of Formula I have n=0; wherein from about 0.001% to about 25% by weight of the first surfactant are surfactants of Formula II; and wherein X is a hydrophilic moiety.

X can be, for example, neutralized with sodium hydroxide, potassium hydroxide, magnesium hydroxide, lithium hydroxide, calcium hydroxide, ammonium hydroxide, monoethanolamine, diethanolamine, triethanolamine, monoisopropanolamine, diamine, polyamine, primary amine, secondary amine, tertiary amine, amine containing surfactant, or a combination thereof.

X may be selected from sulfates, alkoxylated alkyl sulfates, sulfonates, amine oxides, polyalkoxylates, polyhydroxy moieties, phosphate esters, glycerol sulfonates, polygluconates, polyphosphate esters, phosphonates, sulfosuccinates, sulfosuccaminates, polyalkoxylated carboxylates, glucamides, taurinates, sarcosinates, glycinates, isethionates, dialkanolamides, monoalkanolamides, monoalkanolamide sulfates, diglycolamides, diglycolamide sulfates, glycerol esters, glycerol ester sulfates, glycerol ethers, glycerol ether sulfates, polyglycerol ethers, polyglycerol ether sulfates, sorbitan esters, polyalkoxylated sorbitan esters, ammonioalkanesulfonates, amidopropyl betaines, alkylated quats, alkyated/polyhydroxyalkylated quats, alkylated/polyhydroxylated oxypropyl quats, imidazolines, 2-yl-succinates, sulfonated alkyl esters, sulfonated fatty acids, and mixtures thereof.

The first surfactant may have between about 15% to about 40% of the mixture of surfactant isomers of Formula I have n=1, such as, for example between about 20% to about 40%, between about 25% to about 35%, or between about 30% to about 40%. The first surfactant may have between about 60% to about 90% of the mixture of surfactant isomers of Formula I have n<3, such as, for example between about 65% and 85%, between about 70% and 90%, or between about 80% and 90%. The detergent composition may have between about 90% to about 100% of the first surfactant where the isomers have m+n=11, such as, for example between about 95% and 100%.

The first surfactant may have from about 15% to about 40% by weight of the first surfactant mixture are isomers of Formula I with n=1 and from about 5% to about 20% by weight of the first surfactant mixture are isomers of Formula I with n=2. The first surfactant may have no isomers of Formula I with n equal to or greater than 6. The first surfactant may have up to about 40% of the mixture of surfactant isomers of Formula I with n>2. The first surfactant may have up to about 25% of the mixture of surfactant isomers of Formula I have n>2. The first surfactant may have up to about 20% by weight of the Formula II isomer.

The detergent composition may further comprise further an adjunct cleaning additive. The adjunct cleaning additive may be a builder, an organic polymeric compound, an additional enzyme, an enzyme stabilizer, one or more solvents a bleach system, a hueing agent, a chelating agent, a suds suppressor, a conditioning agent, a humectant, a filler or carrier, an alkalinity system, a pH control system, and a buffer, and mixtures thereof.

The detergent composition may further comprise from about 0.1% to about 80% or from 5 to 40%, or from 10 to 30% by weight of the composition of a second surfactant, wherein said second surfactant comprises, preferably consists essentially of a mixture of surfactant isomers of Formula III and surfactants of Formula IV:

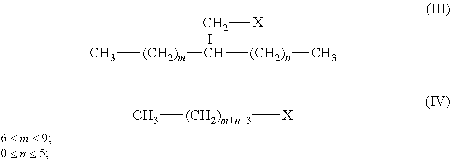

wherein from about 50% to about 100% by weight of the first surfactant are isomers having m+n=9; wherein from about 0.001% to about 25% by weight of the first surfactant are surfactants of Formula IV; and wherein X is a hydrophilic moiety. X can be, for example, neutralized with sodium hydroxide, potassium hydroxide, magnesium hydroxide, lithium hydroxide, calcium hydroxide, ammonium hydroxide, monoethanolamine, diethanolamine, triethanolamine, monoisopropanolamine, diamine, polyamine, primary amine, secondary amine, tertiary amine, amine containing surfactant, or a combination thereof. X may be selected from sulfates, alkoxylated alkyl sulfates, sulfonates, amine oxides, polyalkoxylates, polyhydroxy moieties, phosphate esters, glycerol sulfonates, polygluconates, polyphosphate esters, phosphonates, sulfosuccinates, sulfosuccaminates, polyalkoxylated carboxylates, glucamides, taurinates, sarcosinates, glycinates, isethionates, dialkanolamides, monoalkanolamides, monoalkanolamide sulfates, diglycolamides, diglycolamide sulfates, glycerol esters, glycerol ester sulfates, glycerol ethers, glycerol ether sulfates, polyglycerol ethers, polyglycerol ether sulfates, sorbitan esters, polyalkoxylated sorbitan esters, ammonioalkanesulfonates, amidopropyl betaines, alkylated quats, alkyated/polyhydroxyalkylated quats, alkylated/polyhydroxylated oxypropyl quats, imidazolines, 2-yl-succinates, sulfonated alkyl esters, sulfonated fatty acids, and mixtures thereof.

Between about 25% to about 50% of the mixture of second surfactant isomers of Formula III may have n=0, such as, for example between 30% and 45%, between 35% and 45%, or between 40% and 50%. Between about 15% to about 40% of the mixture of second surfactant isomers of Formula III may have n=1, such as, for example, between 20% and 40%, between 25% and 35%, or between 30% and 40%. Between about 50% to about 90% of the mixture of second surfactant isomers of Formula III may have n<3, such as, for example between 55% and 90%, between 60% and 80%, or between 70% and 90%. Between about 90% to about 100% of the second surfactant may comprise isomers having m+n=9, such as, for example between 95% and 100%.

The second surfactant may have from about 25% to about 50% by weight of the second surfactant mixture are isomers of Formula III with n=0, from about 15% to about 40% by weight of the second surfactant mixture are isomers of Formula III with n=1, and from about 5% to about 20% by weight of the second surfactant mixture are isomers of Formula III with n=2. Up to about 40% of the mixture of surfactant isomers of Formula III may have n>2. Up to about 35% of the mixture of surfactant isomers of Formula III may have n>2. The second surfactant mixture of surfactants may comprise up to about 20% by weight of the Formula IV isomer.

The detergent composition may comprise a surfactant system comprising between about 30 to about 99% of the first surfactant and between about 0.5% to about 40% of the second surfactant, preferably 0.5 to 20% of the second surfactant, more preferably 0.5 to 12.5% of the second surfactant. The detergent composition may comprise a surfactant system comprising between about 60% to about 99% of the first surfactant and up to about 25% of the second surfactant.

The detergent composition may comprise the second surfactant and the first surfactant at a ratio between 0.5:10 to 4:10, such as, for example, 1:10, 2:10, or 3:10.

The detergent composition may further comprise one or more additional surfactant(s) selected from the group consisting of an anionic surfactant, a cationic surfactant, a nonionic surfactant, an amphoteric surfactant, a zwitterionic surfactant, or mixtures thereof; or wherein said detergent composition comprises an anionic surfactant selected from alkyl benzene sulfonates, alkoxylated alkyl sulfates, alkyl sulfates, and mixtures thereof.

The detergent composition may be in a form selected from the group consisting of a granular detergent, a bar-form detergent, a liquid laundry detergent, a gel detergent, a single-phase or multi-phase unit dose detergent, a detergent contained in a single-phase or multi-phase or multi-compartment water soluble pouch, a liquid hand dishwashing composition, a laundry pretreat product, a multi-compartment non-dissolvable package, a detergent contained on or in a porous substrate or nonwoven sheet, an automatic dish-washing detergent, a hard surface cleaner, a fabric softener composition, and mixtures thereof.

The detergent composition may be incorporated into a fibrous product. The detergent composition may be incorporated into the fibers of a fibrous product, particles within a fibrous product, or a combination thereof.

The detergent composition may have from about 0.1% to about 100% of the carbon content of the first surfactant, the second surfactant, or a combination thereof that is derived from renewable sources.

The detergent composition may be used in a method of pretreating or treating a soiled fabric comprising contacting the soiled fabric with the detergent composition.

### Xyloglucanase

A xyloglucanase is an enzyme having xyloglucanase activity. The term “xyloglucanase activity” is defined herein as an enzyme catalyzed hydrolysis of xyloglucan. The reaction involves endo hydrolysis of 1, 4-beta-D-glucosidic linkages in xyloglucan. For purposes of the present invention, xyloglucanase activity is determined using AZCL-xyloglucan (from Megazyme) as the reaction substrate. The assay can be performed in several ways, e.g. as described in Example 2 of WO2023/165507 or as described in WO 01/62903. One unit of xyloglucanase activity (XyloU) is defined by reference to the assay method described in WO 01/62903, page 60, lines 3-17.

### REFERENCE TO AN ELECTRONIC SEQUENCE LISTING

The contents of the electronic sequence listing (16632 sequence listing XML; Size: 10,481 bytes; and Date of Creation: Nov. 1, 2023) is herein incorporated by reference in its entirety.

### Sequence Overview

SEQ ID NO: 1 according to WO2023/165507 is a xyloglucanase obtained from Paenibacillus polymyxa.
SEQ ID NO: 2 according to WO2023/165507 is a xyloglucanase obtained from Paenibacillus polymyxa.
SEQ ID NO: 3 according to WO2023/165507 is a xyloglucanase obtained from Paenibacillus polymyxa.
SEQ ID NO: 4 according to WO2023/165507 is a xyloglucanase obtained from Paenibacillus polymyxa.
SEQ ID NO: 5 according to WO2023/165507 is a xyloglucanase obtained from Paenibacillus polymyxa.
SEQ ID NO: 6 according to WO2023/165507 is a xyloglucanase obtained from Paenibacillus polymyxa.
SEQ ID NO: 7 according to WO2023/165507 is a xyloglucanase obtained from Paenibacillus polymyxa.

A xyloglucanase suitable for use in the detergent composition of the invention is preferably a microbial xyloglucanase, such as bacterial or fungal xyloglucanase.

In an embodiment, the xyloglucanase is obtained from Paenibacillus in particular Paenibacillus polymyxa. In an embodiment, the xyloglucanase comprises the amino acid sequence of SEQ ID NO: 1 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 1.

In an embodiment, the xyloglucanase is obtained from Paenibacillus in particular Paenibacillus polymyxa. In an embodiment, the xyloglucanase comprises the amino acid sequence of SEQ ID NO: 2 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 2.

In an embodiment, the xyloglucanase is obtained from Paenibacillus in particular Paenibacillus polymyxa. In an embodiment, the xyloglucanase comprises the amino acid sequence of SEQ ID NO: 3 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 3.

In an embodiment, the xyloglucanase is obtained from Paenibacillus in particular Paenibacillus polymyxa. In an embodiment, the xyloglucanase comprises the amino acid sequence of SEQ ID NO: 4 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 4.

In an embodiment, the xyloglucanase is obtained from Paenibacillus in particular Paenibacillus polymyxa. In an embodiment, the xyloglucanase comprises the amino acid sequence of SEQ ID NO: 5 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 5.

In an embodiment, the xyloglucanase is obtained from Paenibacillus in particular Paenibacillus polymyxa. In an embodiment, the xyloglucanase comprises the amino acid sequence of SEQ ID NO: 6 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 6.

In an embodiment, the xyloglucanase is obtained from Paenibacillus in particular Paenibacillus polymyxa. In an embodiment, the xyloglucanase comprises the amino acid sequence of SEQ ID NO: 7 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 7.

In an embodiment, the xyloglucanase of SEQ ID NO: 1 or the xyloglucanase of SEQ ID NO: 2, SEQ ID NO: 3, or the xyloglucanase of SEQ ID NO: 4 or the xyloglucanase of SEQ ID NO: 5 or the xyloglucanase of SEQ ID NO: 6 or the xyloglucanase of SEQ ID NO: 7 comprises a substitution, deletion, and/or insertion at one or more (e.g., several) positions. In an embodiment, the number of amino acid substitutions, deletions and/or insertions introduced into the xyloglucanase of SEQ ID NO: 1 or the xyloglucanase of SEQ ID NO: 2, SEQ ID NO: 3, or the xyloglucanase of SEQ ID NO: 4 or the xyloglucanase of SEQ ID NO: 5 or the xyloglucanase of SEQ ID NO: 6, or the xyloglucanase of SEQ ID NO: 7 is not more than 10, e.g., 1, 2, 3, 4, 5, 6, 7, 8 or 9. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding domain.

Other suitable xylogucanases for use herein include a yloglucanase variant, comprising an alteration at one or more positions corresponding to positions selected from the group consisting of 111, 123, 159, 256, 294, 8, 18, 20, 41, 42, 76, 82, 83, 87, 94, 103, 104, 105, 121, 125, 126, 127, 136, 137, 146, 147, 148, 152, 153, 155, 165, 168, 169, 177, 184, 189, 203, 206, 210, 211, 214, 217, 219, 220, 226, 237, 238, 240, 243, 244, 248, 251, 252, 267, 271, 276, 289, 295, 298, 300, 302, 322, 329, 339, 347, 347, 353, 383, 384, 392, 394, 395, 402, 414, 427, 431, 445, 447, 459, 473, 474, 476, 482, 488, 489, 491, 492, 503 and 505 of the polypeptide of SEQ ID NO: 1 according to WO2022/043321, wherein the variant has xyloglucanase activity.

The composition of the invention comprises a xyloglucanase, preferably in a level of from 0.0001 to 2%, preferably from 0.001 to 0.5% of active enzyme by weight of the detergent composition. Suitable xyloglucanases are sold under the tradename Whitezyme (Novozymes A/S, Bagsvaerd, Denmark). Examples include Whitezyme 1.5T, Whitezyme 2.0 L.

### Perfume

The detergent compositions of the invention comprise perfume. Typically, the composition comprises a perfume that comprises one or more perfume raw materials, selected from the group as described in WO08/87497. However, any perfume useful in a detergent composition, preferably in a laundry care composition may be used.

### Optional Ingredients

The detergent compositions may comprise an additional surfactant (e.g., a third surfactant, a fourth surfactant) selected from the group consisting of anionic surfactants, nonionic surfactants, cationic surfactants, zwitterionic surfactants, amphoteric surfactants, ampholytic surfactants, and mixtures thereof. The additional surfactant may be a detersive surfactant, which those of ordinary skill in the art will understand to encompass any surfactant or mixture of surfactants that provide cleaning, stain removing, or laundering benefit to soiled material. The additional surfactant may comprise an alkylethoxysulfates, linear alkyl benzene sulfonates, alcohol ethoxylates, amine oxides, linear alkyl sulfates or combinations thereof. The additional surfactant may contain carbon content derived from renewable sources. The detergent compositions may comprise from 0.5% to 40%, 2% to 30%, 5% to 25% or even 10% to 20% by weight of the detergent composition of additional surfactant. The detergent compositions may contain less than 3%, less than 1% or even less than 0.5% alkylethoxysulfate.

The detergent composition may additionally comprise one or more of the following optional ingredients: external structurant or thickener, additional enzymes, enzyme stabilizers, polymers, bleaching systems, hueing dyes, particulate material, odour control agents, hydrotropes, suds suppressors, fabric care benefit agents, pH adjusting agents, dye transfer inhibiting agents, preservatives, non-fabric substantive dyes and mixtures thereof. In more preferred embodiments, the laundry detergent composition does not comprise a bleach.

External structurant or thickener: Preferred external structurants and thickeners are those that do not rely on charge-charge interactions for providing a structuring benefit. As such, particularly preferred external structurants are uncharged external structurants, such as those selected from the group consisting of: non-polymeric crystalline, hydroxyl functional structurants, such as hydrogenated castor oil; microfibrillated cellulose; uncharged hydroxyethyl cellulose; uncharged hydrophobically modified hydroxyethyl cellulose; hydrophobically modified ethoxylated urethanes; hydrophobically modified non-ionic polyols; and mixtures thereof.

Suitable polymeric structurants include naturally derived and/or synthetic polymeric structurants. Examples of naturally derived polymeric structurants of use in the present invention include: microfibrillated cellulose, hydroxyethyl cellulose, hydrophobically modified hydroxyethyl cellulose, carboxymethyl cellulose, polysaccharide derivatives and mixtures thereof. Non-limiting examples of microfibrillated cellulose are described in WO 2009/101545 A1. Suitable polysaccharide derivatives include: pectine, alginate, arabinogalactan (gum Arabic), carrageenan, gellan gum, xanthan gum, guar gum and mixtures thereof. Examples of synthetic polymeric structurants or thickeners of use in the present invention include: polycarboxylates, hydrophobically modified ethoxylated urethanes (HEUr), hydrophobically modified non-ionic polyols and mixtures thereof.

Preferably, the aqueous liquid detergent composition has a viscosity of 50 to 5,000, preferably 75 to 1,000, more preferably 100 to 500 mPa·s, when measured at a shear rate of 100 s-1, at a temperature of 20° C. For improved phase stability, and also improved stability of suspended ingredients, the aqueous liquid detergent composition has a viscosity of 50 to 250,000, preferably 5,000 to 125,000, more preferably 10,000 to 35,000 mPa·s, when measured at a shear rate of 0.05 s-1, at a temperature of 20° C.

Cleaning polymers: The detergent composition preferably comprises a cleaning polymer. Such cleaning polymers are believed to at least partially lift the stain from the textile fibres and enable the enzyme system to more effectively break up the complexes comprising mannan and other polysaccharide. Suitable cleaning polymers provide for broad-range soil cleaning of surfaces and fabrics. Examples of suitable cleaning polymers include: amphiphilic alkoxylated grease cleaning polymers; clay soil cleaning polymers; and soil suspending polymers. A preferred cleaning polymer is obtainable by free-radical copolymerization of at least one compound of formula (I),

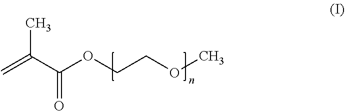

in which n is equal to or greater than 3 for a number,
with at least one compound of formula (II),

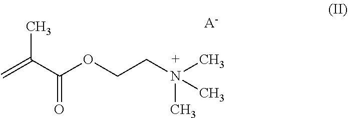

in which A-represents an anion, in particular selected from halides such as fluoride, chloride, bromide, iodide, sulfate, hydrogen sulfate, alkyl sulfate such as methyl sulfate, and mixtures thereof. Such polymers are further described in EP3196283A1.

Other useful cleaning polymers are described in USPN 2009/0124528A1. The detergent composition may comprise amphiphilic alkoxylated grease cleaning polymers, which may have balanced hydrophilic and hydrophobic properties such that they remove grease particles from fabrics and surfaces. The amphiphilic alkoxylated grease cleaning polymers may comprise a core structure and a plurality of alkoxylate groups attached to that core structure. These may comprise alkoxylated polyalkyleneimines, for example. Such compounds may comprise, but are not limited to, ethoxylated polyethyleneimine, ethoxylated hexamethylene diamine, and sulfated versions thereof. Polypropoxylated derivatives may also be included. A wide variety of amines and polyalklyeneimines can be alkoxylated to various degrees. A useful example is 600 g/mol polyethyleneimine core ethoxylated to 20 EO groups per NH and is available from BASF. The alkoxylated polyalkyleneimines may have an inner polyethylene oxide block and an outer polypropylene oxide block. The detergent compositions may comprise from 0.1% to 10%, preferably, from 0.1% to 8%, more preferably from 0.1% to 2%, by weight of the detergent composition, of the cleaning polymer.

Dye transfer inhibitor: The detergent composition can comprise a dye transfer inhibitor. Suitable dye transfer inhibitors can be selected from the group consisting of polyvinylpyrrolidone (PVP), polyvinylimidazole (PVI), copolymers of vinylpyrrolidone and vinylimidazole (PVP/PVI), polyvinyl pyridine-N-oxide, poly-N-carboxymethyl-4-vinylpyridiumchloride, and mixtures thereof, with polyvinylpyrrolidone (PVP), polyvinylimidazole (PVI), copolymers of vinylpyrrolidone and vinylimidazole (PVP/PVI), and mixtures thereof being particularly preferred. The dye transfer inhibitor can be present at a level of from 0.05% to 5%, preferably from 0.1% to 3%, and more preferably from 0.2% to 2.5%, by weight of the detergent composition.

Polymer Deposition Aid: The laundry detergent composition can comprise from 0.1% to 7%, more preferably from 0.2% to 3%, of a polymer deposition aid. As used herein, “polymer deposition aid” refers to any cationic polymer or combination of cationic polymers that significantly enhance deposition of a fabric care benefit agent onto the fabric during laundering. Suitable polymer deposition aids can comprise a cationic polysaccharide and/or a copolymer, with cationic polysaccharide being preferred and polyquaternium 7 being most preferred. “Fabric care benefit agent” as used herein refers to any material that can provide fabric care benefits. Non-limiting examples of fabric care benefit agents include: silicone derivatives, oily sugar derivatives, dispersible polyolefins, polymer latexes, cationic surfactants and combinations thereof. Preferably, the deposition aid is a cationic or amphoteric polymer. The cationic charge density of the polymer preferably ranges from 0.05 milliequivalents/g to 6 milliequivalents/g. The charge density is calculated by dividing the number of net charge per repeating unit by the molecular weight of the repeating unit. In one embodiment, the charge density varies from 0.1 milliequivalents/g to 3 milliequivalents/g. The positive charges could be on the backbone of the polymers or the side chains of polymers.

Organic builder and/or chelant: The laundry detergent composition can comprise from 0.6% to 10%, preferably from 2 to 7% by weight of one or more organic builder and/or chelants. Suitable organic builders and/or chelants are selected from the group consisting of: MEA citrate, citric acid, aminoalkylenepoly(alkylene phosphonates), alkali metal ethane 1-hydroxy disphosphonates, and nitrilotrimethylene, phosphonates, diethylene triamine penta (methylene phosphonic acid) (DTPMP), ethylene diamine tetra(methylene phosphonic acid) (DDTMP), hexamethylene diamine tetra(methylene phosphonic acid), hydroxy-ethylene 1,1 diphosphonic acid (HEDP), hydroxyethane dimethylene phosphonic acid, ethylene di-amine di-succinic acid (EDDS), ethylene diamine tetraacetic acid (EDTA), hydroxyethylethylenediamine triacetate (HEDTA), nitrilotriacetate (NTA), methylglycinediacetate (MGDA), iminodisuccinate (IDS), hydroxyethyliminodisuccinate (HIDS), hydroxyethyliminodiacetate (HEIDA), glycine diacetate (GLDA), diethylene triamine pentaacetic acid (DTPA), catechol sulfonates such as TironTM and mixtures thereof.

### Other Enzymes

The detergent composition may comprise other enzymes in addition to the xylogluconase. Suitable enzymes provide cleaning performance and/or fabric care benefits. Examples of other suitable enzymes include, but are not limited to amylase, peroxidases, proteases, xylanases, lipases, cellulases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or combinations thereof. A preferred enzyme system further comprises a cocktail of conventional detersive enzymes such as amylase, protease, lipase, cellulase and/or cutinase. Detersive enzymes are described in greater detail in U.S. Pat. No. 6,579,839.

Enzyme stabiliser: Enzymes can be stabilized using any known stabilizer system such as calcium and/or magnesium compounds, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof. The composition is preferably free of borate.

Hueing dyes: The detergent composition may comprise fabric hueing agent (sometimes referred to as shading, bluing, or whitening agents). Typically the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and combinations thereof.

Hydrotrope: The detergent composition may comprise, based on the total detergent composition weight, from 0 to 30%, preferably from 0.5 to 5%, more preferably from 1.0 to 3.0%, which can prevent liquid crystal formation. The addition of the hydrotrope thus aids the clarity/transparency of the composition. Suitable hydrotropes comprise but are not limited to urea, salts of benzene sulphonate, toluene sulphonate, xylene sulphonate or cumene sulphonate. Preferably, the hydrotrope is selected from the group consisting of propylene glycol, xylene sulfonate, ethanol, and urea to provide optimum performance.

Particles: The composition can also comprise particles, especially when the composition further comprises a structurant or thickener. The composition may comprise, based on the total composition weight, from 0.02% to 10%, preferably from 0.1% to 4%, more preferably from 0.25% to 2.5% of particles. Said particles include beads, pearlescent agents, microcapsules, and mixtures thereof.

Microcapsules: Suitable capsules are typically formed by at least partially, preferably fully, surrounding a benefit agent with a wall material. Preferably, the capsule is a perfume capsule, wherein said benefit agent comprises one or more perfume raw materials. The capsule wall material may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, resorcinol-based materials, poly-isocyanate-based materials, acetals (such as 1,3,5-triol-benzene-gluteraldehyde and 1,3,5-triol-benzene melamine), starch, cellulose acetate phthalate and mixtures thereof. Preferably, the capsule wall comprises melamine and/or a polyacrylate based material. The perfume capsule may be coated with a deposition aid, a cationic polymer, a non-ionic polymer, an anionic polymer, or mixtures thereof. Preferably, the perfume capsules have a volume weighted mean particle size from 0.1 microns to 100 microns, preferably from 0.5 microns to 60 microns. Especially where the composition comprises capsules having a shell formed at least partially from formaldehyde, the composition can additionally comprise one or more formaldehyde scavengers.

### Process of Making the Laundry Detergent Composition:

The detergent compositions can be made using any suitable process known to the skilled person. Typically, the ingredients are blended together in any suitable order. Preferably, the detersive surfactants are added as part of a concentrated premix, to which are added the other optional ingredients. Preferably, the solvent is added either last, or if an external structurant is added, immediately before the external structurant, with the external structurant being added as the last ingredient.

### Method of Laundering Fabrics:

The detergent compositions of the present invention can be used to launder fabrics. In such methods, the laundry detergent composition is diluted to provide a wash liquor having a total surfactant concentration of greater than 100 ppm, preferably from 200 ppm to 2,000 ppm, more preferably from 300 ppm to 1000 ppm. The fabric is then washed in the wash liquor, and preferably rinsed.

### Methods:

### A) pH Measurement:

The pH is measured, at 25° C., using a Santarius PT-10P PH meter with gel-filled probe (such as the Toledo probe, part number 52 000 100), calibrated according to the instructions manual. The pH is measured in a 10% dilution in demineralised water (i.e. 1 part laundry detergent composition and 9 parts demineralised water).

### B) Method of Measuring Viscosity:

The viscosity is measured using an AR 2000 rheometer from TA instruments using a cone and plate geometry with a 40 mm diameter and an angle of 1°. The viscosity at the different shear rates is measured via a logarithmic shear rate sweep from 0.1 s-1 to 1200 s-1 in 3 minutes time at 20° C. Low shear viscosity is measured at a continuous shear rate of 0.05 s-1.

### Examples

Dry fabric odour headspace was measured for detergent compositions comprising: i) branched surfactant and no xyloglucanase, ii) a xyloglucanase and no branched surfactant; and iii) a combination of branched surfactant and xyloglucanase. A synergy was observed in the case of detergent composition comprising a combination of branched surfactant and xyloglucanase.

### Fabric Odour Headspace Analysis

The method involves the use of a tergotometer to simulate the washing of fabrics in a washing machine. Terry fabrics were ordered from Calderon (Indianapolis, IN, USA). Fabrics were stripped using 2 wash and rinse cycles using 48 g AATCC detergent in 140° F. and soft water and 2 wash and rinse cycles without product in 140° F. soft water. Preconditioned fabrics were generated using 3 detergent/fabric enhancer cycles using 85 g nil-perfume detergent and 48.5 g liquid nil-perfume fabric enhancer. Each cycle is run with 7 gpg water in 90° F. wash/60° F. rinse.

Wash tests consisted of four internal and three external replicates for each treatments A-J described below (Table 2). Each wash test contained a ratio of 18.93 L water to 40.5 g liquid detergent test compositions, test fabrics at 25° C. and 7 US gpg, agitated for 12 minutes, rinsed in 25 C water at 7 US gpg for 3 minutes, and spun dry. After the rinse, fabrics were dried at 145 F for 30 minutes. Before the fabrics were analysed, the fabrics were exposed to 73 F and 50% humidity for 4 hours. GCMS headspace analysis was used on each fabric sample, with the method described below.

Fabric headspace analysis is performed using Solid-phase Micro Extraction Gas Chromatography Mass Spectrometry (SPME GC-MS) described below. Typically, greater perfume intensity (as measured by headspace analysis) correlates with higher concentrations of perfume on fabric.

Headspace analysis is done on four treated fabrics from three different wash cycles for a total of twelve fabrics. Approximately eight 1 cm dots of test fabrics are placed into a 20 mL headspace sample vial (#24694, available from Restek, Bellefonte, PA), and the vial is capped (#093640-094-00 available from Gerstel, Linthicum, MD). Dry fabrics are equilibrated for 4 hours in a constant temperature and humidity room at 21 C and 50% RH prior to capping.

The sample vials are then loaded onto a Gerstel MPS2 Autosampler (Gerstel Inc., Linthicum, MD, USA). Prior to the headspace analysis, each sample is pre-conditioned in the machine at 65° C. for 10 minutes. Headspace is extracted onto an Agilent 7890B/5977A GC-MS system (Agilent Technologies, Santa Clara, CA, USA) equipped with a Supelco 50/30 micrometer DVB/CAR/PDMS 23Ga. Solid Phase Micro Extraction fiber (Supelco Inc., Bellefonte, PA, USA). GC analysis is conducted on a non-polar capillary column (DB-5 MS UI, 30 meters nominal diameter, 0.25-millimeter nominal diameter, 25 micrometer thickness) and the headspace constituents (i.e., the perfume raw materials) are monitored by Mass Spectrometry (EI, 70 eV detector). Headspace intensity is calculated utilizing a single point calibration of the perfume raw materials. The total headspace concentration for each vial is calculated from the sum of the concentration of each detected perfume raw material, and the headspace is averaged for the twelve treated fabrics. Headspace improvement may be determined relative to the reference treatment.

The results in Table 1 demonstrate the dry fabric odour headspace advantages when combining Whitezyme 2.0 (WZ) and Branched Alkyl Sulfate, versus the expected independently additive benefit using Whitezyme 2.0 or Branched Alkyl Sulfate.

TABLE 1
Measured dry fabric odor (DFO) headspace (nmol/L) compared
to Composition A (reference) when analyzed via GCMS.

| | | | Expected | 0.009% WZ 2.0, | |
|---|---|---|---|---|---|
| | 0.009% WZ 2.0 | 1.75% Branched | Result | 1.75% Branched | Synergy |
| | (G) | Alkyl Sulfate (B) | (B) + (G) | Alkyl Sulfate (H) | (H > B + G) |
| Delta Headspace | 1.28 | −0.55 | 0.65 | 0.92 | 42% more than |
| vs reference (A) | | | | | expected |
| | | | Expected | 0.006% WZ 2.0, | |
| | 0.006% WZ 2.0 | 1.75% Branched | Result | 1.75% Branched | Synergy |
| | (E) | Alkyl Sulfate (B) | (B) + (E) | Alkyl Sulfate (F) | (F > B + E) |
| Delta Headspace | −0.62 | −0.55 | −1.17 | 0.46 | 139% more than |
| vs reference (A) | | | | | expected |
| | | | Expected | 0.003% WZ 2.0, | |
| | 0.003% WZ 2.0 | 1.75% Branched | Result | 1.75% Branched | Synergy |
| | (C) | Alkyl Sulfate (B) | (B) + (C) | Alkyl Sulfate (D) | (D > B + C) |
| Delta Headspace | −0.72 | −0.55 | −1.27 | −0.86 | 32% more than |
| vs reference (A) | | | | | expected |
| | | | Expected | 0.003% WZ 2.0, | |
| | 0.003% WZ 2.0 | 0.875% Branched | Result | 0.875% Branched | Synergy |
| | (C) | Alkyl Sulfate (I) | (I) + (C) | Alkyl Sulfate (J) | (J > C + I) |
| Delta Headspace | −0.72 | −0.40 | −1.12 | 1.80 | 261% more than |
| vs reference (A) | | | | | expected |

TABLE 2
Formulation Composition (raw materials expressed as % active by weight of the composition)

| | A | B | C | D | E | F | G | H | I | J |
|---|---|---|---|---|---|---|---|---|---|---|
| Whitezyme 2.0 | — | | 0.003 | 0.003 | 0.006 | 0.006 | 0.009 | 0.009 | — | 0.003 |
| BAS² | — | 1.75 | — | 1.75 | — | 1.75 | — | 1.75 | 0.875 | 0.875 |
| SLS³ | 3.466 | 3.466 | 3.466 | 3.466 | 3.466 | 3.466 | 3.466 | 3.466 | 3.466 | 3.466 |
| AES⁴ | 2.072 | 2.072 | 2.072 | 2.072 | 2.072 | 2.072 | 2.072 | 2.072 | 2.072 | 2.072 |
| HLAS⁵ | 10.712 | 10.712 | 10.712 | 10.712 | 10.712 | 10.712 | 10.712 | 10.712 | 10.712 | 10.712 |
| NI⁶ | 12.001 | 12.001 | 12.001 | 12.001 | 12.001 | 12.001 | 12.001 | 12.001 | 12.001 | 12.001 |
| AO⁷ | 0.358 | 0.358 | 0.358 | 0.358 | 0.358 | 0.358 | 0.358 | 0.358 | 0.358 | 0.358 |
| Chelant⁸ | 0.260 | 0.260 | 0.260 | 0.260 | 0.260 | 0.260 | 0.260 | 0.260 | 0.260 | 0.260 |
| Citric acid⁹ | 0.652 | 0.652 | 0.652 | 0.652 | 0.652 | 0.652 | 0.652 | 0.652 | 0.652 | 0.652 |
| Protease ¹⁰ | 0.080 | 0.080 | 0.080 | 0.080 | 0.080 | 0.080 | 0.080 | 0.080 | 0.080 | 0.080 |
| Mannanase¹¹ | 0.001 | 0.001 | 0.001 | 0.001 | 0.001 | 0.001 | 0.001 | 0.001 | 0.001 | 0.001 |
| Amylase ¹² | 0.013 | 0.013 | 0.013 | 0.013 | 0.013 | 0.013 | 0.013 | 0.013 | 0.013 | 0.013 |
| PEI¹³ | 0.624 | 0.624 | 0.624 | 0.624 | 0.624 | 0.624 | 0.624 | 0.624 | 0.624 | 0.624 |
| PEI¹⁴ | 1.50 | 1.50 | 1.50 | 1.50 | 1.50 | 1.50 | 1.50 | 1.50 | 1.50 | 1.5 |
| Perfume | 0.74 | 0.74 | 0.74 | 0.74 | 0.74 | 0.74 | 0.74 | 0.74 | 0.74 | 0.74 |

¹Whitezyme 2.0 (WZ) commercially available from Novozyme
²Branched Alkyl Sulfate as specified in US2023-0174893, Examples 1 and 2, Page 10, Paragraphs 96-99
³C12/C14 Alkyl Sulfate sourced from P&G Chemicals
⁴C12-15EO2.5S AlkylethoxySulfate where the alkyl portion of AES includes from about 13.9 to 14.6 carbon atoms
⁵Linear Alkyl Benzene Sulfonate sourced from P&G Chemicals
⁶Surfonic L24-9 commercially available from Huntsman and Neodol 45-7 commercially available from Shell Chemicals
⁷Natural C12/14 Amine Oxide available from P&G Chemicals
⁸Chelant is DISSOLVINE GL-47-S commercially available from AkzoNobel
⁹Citrosol 502 commercially available from Archer Daniels Midland
¹⁰ Protease commercially available from IFF
¹¹Mannanase commercially available from Novozymes
¹² Amylase commercially available from Novozymes
¹³Ethoxylated polyethyleneimine commercially available from BASF
¹⁴PEI600 E024 PO16 commercially available from BASF

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising:
a) from about 1% to about 80% by weight of the composition of a first surfactant, wherein said first surfactant comprises a mixture of surfactant isomers of Formula I and surfactants of Formula II: 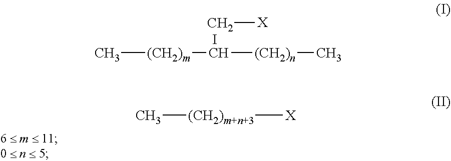
wherein about 50% to about 100% by weight of the first surfactant are isomers having m+n=11; wherein between about 25% to about 50% of the mixture of surfactant isomers of Formula I have n=0; wherein from about 0.001% to about 25% by weight of the first surfactant are surfactants of Formula II; and wherein X is a hydrophilic moiety
b) a xyloglucanase;
c) perfume; and
wherein the composition is substantially free of optical brightener.

2. The detergent composition according to claim 1, wherein about 15% to about 40% of the mixture of surfactant isomers of Formula I have n=1.

3. The detergent composition according to claim 1, wherein about 60% to about 90% of the mixture of surfactant isomers of Formula I have n<3.

4. The detergent composition according to claim 1, wherein about 90% to about 100% of the first surfactant are isomers having m+n=11.5.

5. The detergent composition according to claim 1, wherein the detergent composition further comprises from about 0.5% to about 12.5% by weight of the composition of a second surfactant, wherein said second surfactant comprises a mixture of surfactant isomers of Formula III and surfactants of Formula IV: 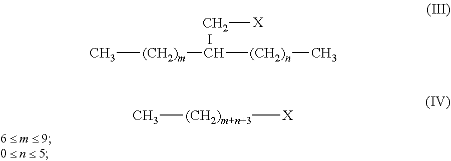
wherein from about 50% to about 100% by weight of the second surfactant are isomers having m+n=9; wherein from about 0.001% to about 25% by weight of the second surfactant are surfactants of Formula IV; and wherein X is a hydrophilic moiety.

6. The detergent composition according to claim 1, wherein the detergent composition further comprises from about 0.5% to about 12.5% by weight of the composition of a second surfactant, wherein said second surfactant comprises a mixture of surfactant isomers of Formula III and surfactants of Formula IV: 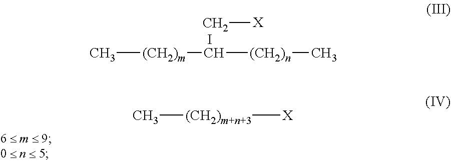
wherein from about 50% to about 100% by weight of the second surfactant are isomers having m+n=9; wherein from about 0.001% to about 25% by weight of the second surfactant are surfactants of Formula IV; and wherein X is a hydrophilic moiety and wherein about 25% to about 50% of the mixture of surfactant isomers of Formula III have n=0.

7. The detergent composition according to claim 1, wherein the detergent composition further comprises from about 0.5% to about 12.5% by weight of the composition of a second surfactant, wherein said second surfactant comprises a mixture of surfactant isomers of Formula III and surfactants of Formula IV: 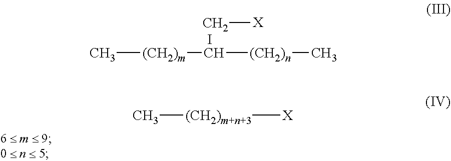
wherein from about 50% to about 100% by weight of the second surfactant are isomers having m+n=9; wherein from about 0.001% to about 25% by weight of the second surfactant are surfactants of Formula IV; and wherein X is a hydrophilic moiety and wherein 15% to 40% of the mixture of surfactant isomers of Formula III have n=1.

8. The detergent composition according to claim 1, wherein the detergent composition further comprises from about 0.5% to about 12.5% by weight of the composition of a second surfactant, wherein said second surfactant comprises a mixture of surfactant isomers of Formula III and surfactants of Formula IV: 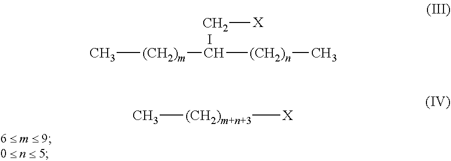
wherein from about 50% to about 100% by weight of the second surfactant are isomers having m+n=9; wherein from about 0.001% to about 25% by weight of the second surfactant are surfactants of Formula IV; and wherein X is a hydrophilic moiety and wherein 50% to 90% of the mixture of surfactant isomers of Formula III have n<3.

9. The detergent composition according to claim 1, wherein the detergent composition further comprises from about 0.5% to about 12.5% by weight of the composition of a second surfactant, wherein said second surfactant comprises a mixture of surfactant isomers of Formula III and surfactants of Formula IV: 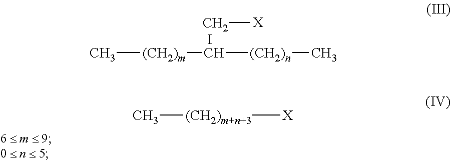
wherein from about 50% to about 100% by weight of the second surfactant are isomers having m+n=9; wherein from about 0.001% to about 25% by weight of the second surfactant are surfactants of Formula IV; and wherein X is a hydrophilic moiety and wherein about 25% to about 50% by weight of the second surfactant mixture are isomers of Formula III with n=0, from 15% to 40% by weight of the second surfactant mixture are isomers of Formula III with n=1, and from about 5% to about 20% by weight of the second surfactant mixture are isomers of Formula III with n=2.

10. The detergent composition according to claim 1, wherein the detergent composition further comprises from about 0.5% to about 12.5% by weight of the composition of a second surfactant, wherein said second surfactant comprises a mixture of surfactant isomers of Formula III and surfactants of Formula IV: 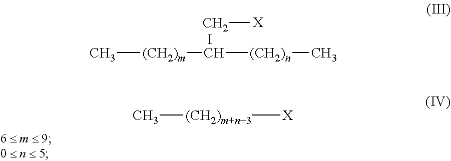
wherein from about 50% to about 100% by weight of the second surfactant are isomers having m+n=9; wherein from about 0.001% to about 25% by weight of the second surfactant are surfactants of Formula IV; and wherein X is a hydrophilic moiety and wherein up to about 35% of the mixture of surfactant isomers of Formula III have n>2.

11. The detergent composition according to claim 1, wherein X is selected from the group consisting of sulfates, alkoxylated alkyl sulfates, sulfonates, amine oxides, polyalkoxylates, polyhydroxy moieties, phosphate esters, glycerol sulfonates, polygluconates, polyphosphate esters, phosphonates, sulfosuccinates, sulfosuccaminates, polyalkoxylated carboxylates, glucamides, taurinates, sarcosinates, glycinates, isethionates, dialkanolamides, monoalkanolamides, monoalkanolamide sulfates, diglycolamides, diglycolamide sulfates, glycerol esters, glycerol ester sulfates, glycerol ethers, glycerol ether sulfates, polyglycerol ethers, polyglycerol ether sulfates, sorbitan esters, polyalkoxylated sorbitan esters, ammonioalkanesulfonates, amidopropyl betaines, alkylated quats, alkyated/polyhydroxyalkylated quats, alkylated/polyhydroxylated oxypropyl quats, imidazolines, 2-yl-succinates, sulfonated alkyl esters, sulfonated fatty acids, and mixtures thereof, preferably X is sulfate.

12. The detergent composition according to claim 1 wherein the xyloglucanase is obtained from a bacterial source, preferably Paenibacillus polymyxa or Bacillus akibai or from a fungal source, preferably Humicola insolens or Thielavia terrestris.

13. The detergent composition according to claim 1 wherein the xyloglucanase has an amino acid sequence selected from the group consisting of SEQ ID NO: 1, SEQ ID NO: 2, SEQ ID NO: 3, SEQ ID NO: 4, SEQ ID NO: 5, SEQ ID NO: 6 and SEQ ID NO: 7, or a xyloglucanase that has an amino acid sequence having at least 60%, at least 65%, at least 70%, at least 75%, at least 80%, at least 85%, at least 90%, at least 95%, at least 96%, at least 97%, at least 98%, at least 99% or at least 100% sequence identity to any of SEQ ID NO: 1, SEQ ID NO: 2, SEQ ID NO: 3, SEQ ID NO: 4, SEQ ID NO: 5, SEQ ID NO: 6 and SEQ ID NO: 7.

14. The detergent composition according to claim 1 wherein the composition is substantially free of borate.

15. The detergent composition according to claim 1 wherein the composition comprises an additional surfactant selected from the group consisting of non-ionic surfactant, alkyl benzene sulfonates, alkoxylated alkyl sulfates, alkyl sulfates, and mixtures thereof.

16. The detergent composition according to claim 1 comprising a non-ionic surfactant wherein the non-ionic is derived from natural sources.

17. The detergent composition according to claim 1 comprising from about 0.01% to less than about 3% by weight of the composition of an alkoxylated alkyl sulfate surfactant.

18. The detergent composition of claim 1, wherein said detergent composition is a form selected from the group consisting of a granular detergent, a bar-form detergent, a liquid laundry detergent, a gel detergent, a single-phase or multi-phase unit dose detergent, a detergent contained in a single-phase or multi-phase or multi-compartment water soluble pouch, a multi-compartment non-dissolvable package, a liquid hand dishwashing composition, a laundry pretreat product, a detergent contained on or in a porous substrate or nonwoven sheet, an automatic dish-washing detergent, a hard surface cleaner, a fabric softener composition, a water soluble fibrous product, and mixtures thereof.

19. A method of laundering fabric wherein the method comprises the steps of:
a) providing a detergent composition according to claim 1;
b) diluting the detergent composition to provide a wash liquor having a total surfactant concentration of greater than about 100 ppm; and
c) washing fabric in the wash liquor.

20. Use of a detergent composition for laundering fabric wherein the detergent composition comprises:
a) from about 5% to about 40% by weight of the composition of a first surfactant, wherein said first surfactant comprises a mixture of surfactant isomers of Formula I and surfactants of Formula II: 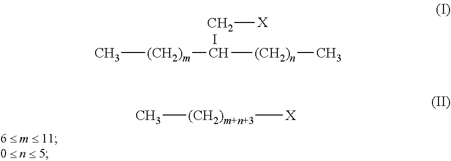
wherein about 50% to about 100% by weight of the first surfactant are isomers having m+n=11; wherein between about 25% to about 50% of the mixture of surfactant isomers of Formula I have n=0; wherein from 0.001% to 25%, preferably from about 0.001% to about 20%, by weight of the first surfactant are surfactants of Formula II; and wherein X is a hydrophilic moiety
b) a xyloglucanase;
c) perfume
to provide improved perfume deposition on the fabric.


SEQUENCE LISTING (7 sequences)

SEQ ID NO: 1 - protein, 524 aa, Paenibacillus polymyxa
VVHGQTAKTITIKVDTFKDRKPISPYIYGTNQDLAGDENMAARRLGGNRMTGYNWENNMSNAGSDWQQSSDNYLCSNGGLTQAECEKPGAVTTSFHDQSLKLGTYSLVTLPMAGYVAKDGNGSVQESEKAPSARWNQVVNAKNAPFQLQPDLNDNRVYVDEFVHFLVNKYGTASTKAGVKGYALDNEPALWSHTHPRIHGEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWNSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 2 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTQAECEKPGAVVTSFHDQSLKLGTYSLVTLPMAGYVAADGNGSVQESEAAPSARWNQVVNAKNAPFQLQPDLNDNYVYVDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 3 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTQAECEKPGAVVTSFHDQSLKLGTYSLVTLPMAGYVAADGNGSVQESETAPSARWNQVVNAKNAPFQLQPDLNDNYVYVDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 4 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTQEECEKPGAVVTSFHDQSLKLGTYSLVTLQMAGYVAADGNGPVQESETAPSARWNQVVNAKNAPFQLQPDLNDNYVYMDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYEWFVDYYLDQMRLSSQVEGKRLLDVFDVHWYPEAMGGGERITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 5 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTEAECEKPGAVVTSFHDQSLKLGTYSLVTLQMAGYVAADGNGPVQESETAPSARWNKVVNAKNAPFQLQPDLNDNYVYMDEFVHFLVNKYGTASTKAGVKGYALDNEPALWSHTHPRIHPEKTGAKELVHRSVSLSKAVKAIDAGAEVFGPVLYGFMAYKDLQTAPDWDSVKGNYEWFVDYYLDQMRLSSQVEGKRLLDVFDVHWYPEAMGGGERITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 6 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTQEECEKPGAVVTSFHDQSLKLGTYSLVTLQMAGYVAADGNGPVQESETAPSARWNKVVNAKNAPFKLQPDLNDNYVYMDEFVHFLVNKYGTASTKAGVKGYAMDNEPALWSHTHPRIHPEKVGAKELVHRSVSLSKAVKAIDAGAEVFGPVLYGFGAYFDLQTAPDWDSEKGNYQWFVDYYLDQMRLSSEVEGKRLLDVFDVHWYPEAMGGGERITNEVGNDETKKARMQAPRTLWDPTYKEDSWIAEWFSEFLPILPRLKQSVDKYYPGTKLAMTEYSYGGENDISGGIAMTDVLGILGKNDVYMANYWKLKDGVNNYVQAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 7 - protein, 514 aa, Paenibacillus polymyxa
QTAKTITIKVDTFKDRKPISPYIYGTNQDLAGDENMAARRLGGNRMTGYNWENNMSNAGSDWQHSSDNYLCSNGGLTQEECEKPGAVVTSFHDQSLKLGTYSLVTLQMAGYVAADGNGPVQESETAPSARWNQVVNAKNAPFQLQPDLNDNYVYMDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYEWFVDYYLDQMRLSSQVEGKRLLDVFDVHWYPEAMGGGERITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTG